(19) United States
(12) Patent Application Publication
(10) Pub. No.: US 2004/0045291 A1
(43) Pub. Date: Mar. 11, 2004

(54) Flow laminarizing device

(76) Inventor: David Meheen, Pasco, WA (US)

Correspondence Address: John S. Reid, South 1926 Valleyview Lane, Spokane, WA, 99212-0157, US

(21) Appl. No.: 10/305,298

(22) Filed: Nov. 26, 2002

Related U.S. Application Data
(60) Provisional application No. 60/408,838, filed on Sep. 6, 2002.

(51) Int. Cl. F02B 33/44

(52) U.S. Cl. 60/605.1

(57) ABSTRACT

Representative embodiments provide for a flow laminarizing device including first walls defining a plurality of mutually parallel passageways, each passageway including open opposite ends. The device further includes second walls defining a plurality of channels, which are substantially parallel with each other and the plurality of passageways. Each channel includes at least one open side and open opposite ends. The passageways and channels are configured to permit fluid flow there through. The flow laminarizing device further includes a retainer configured to support the device in a substantially fixed position with respect to a location of use, and wherein the retainer optionally includes a ring. The invention further provides a method for using a diesel engine including a turbocharger. The method includes receiving a flow of combustion gasses from the diesel engine, and a flow of ambient air, at the turbocharger. The method further includes laminarizing at least one of the flow of combustion gasses or the flow of ambient air prior to the receiving at the turbocharger using a flow laminarizing device.

### CROSS REFERENCE TO RELATED APPLICATIONS

The present invention claims priority under 35 U.S.C. § 120 to U.S. Provisional Patent Application Serial No. 60/408,838, filed Sep. 6, 2002 and hereby incorporated herein by reference in its entirety.

### BACKGROUND

Turbochargers are commonly known devices for increasing the air mass in the combustion chambers (cylinders) of an internal combustion engine, particularly, but not limited to, diesel engines. The turbocharger is most frequently driven by exhaust gasses which are used to drive an impeller. The impeller is attached by a shaft or other coupling to a compressor wheel, which is used to compress ambient air which is then provided to the combustion chambers of the engine. Other kinds of fluid impelling devices use one of more impellers to induce fluid flow through centrifugal force.

Therefore, it is desirable to improve the performance of turbochargers and other kinds of fluid impelling devices.

### SUMMARY

One embodiment provides for a turbocharger including an impeller, a fluid inlet to the impeller, and an outlet from the impeller. A flow laminarizing device is disposed within the inlet to the impeller, or the outlet from the impeller, or flow laminarizing devices are disposed within both the inlet and the outlet. The flow laminarizing device includes a plurality of walls, which define a plurality of passageways, the passageways being substantially mutually parallel and configured to permit fluid flow there through.

Another embodiment provides for a diesel engine including a plurality of combustion chambers, each combustion chamber being configured to receive ambient air and to discharge combustion gases. The diesel engine further includes a turbocharger, which is configured to receive the ambient air, compress the ambient air, and to provide the compressed ambient air to the plurality of combustion chambers. The turbocharger is also configured to receive, and be driven by, the combustion gasses discharged by the diesel engine. The diesel engine further includes a flow laminarizing device, which is configured to laminarize a flow of one of the ambient air to the turbocharger, or the combustion gasses to the turbocharger.

Yet another embodiment provides for a flow laminarizing device that includes a first plurality of first walls defining a plurality of passageways, the plurality of passageways being substantially, mutually parallel and disposed as an array. Each of the passageways includes open opposite ends, and is configured to permit fluid flow there through. The flow laminarizing device also includes a second plurality of second walls defining a plurality of channels, the plurality of channels being substantially parallel with each other and the plurality of passageways. Each of the channels includes at least one open side and open opposite ends, and is configured to permit fluid flow there through. The flow laminarizing device further includes a retainer configured to support the flow laminarizing device in a substantially fixed position with respect to a location of use. The retainer optionally includes a ring.

Still another embodiment provides for a method of using a diesel engine that includes a turbocharger. The method includes receiving a flow of combustion gasses from the diesel engine at the turbocharger, receiving a flow of ambient air at the turbocharger, and laminarizing at least one of the flow of combustion gasses or the flow of ambient air prior to the receiving at the turbocharger using a flow laminarizing device.

These and other aspects and embodiments will now be described in detail with reference to the accompanying drawings, wherein:

### DESCRIPTION OF THE DRAWINGS

FIG. 1 is a schematic view depicting an engine and turbocharger combination in accordance with the prior art.

FIG. 2 is a schematic view depicting an engine and turbocharger combination including a pair of flow laminarizing devices in accordance with one embodiment of the invention.

FIG. 3 is a perspective view depicting a flow laminarizing device in accordance with another embodiment of the invention.

FIG. 4 is a perspective view depicting a turbocharger and the flow laminarizing device of FIG. 3.

FIG. 5 is an end plan view depicting a flow laminarizing device in accordance yet another embodiment of the invention.

FIG. 6 is a side elevational view depicting the flow laminarizing device of FIG. 5.

FIG. 7 is a side elevation sectional view depicting a portion of a turbocharger in combination with the flow laminarizing device of FIG. 5.

FIG. 8 is a schematic view depicting a flow laminarizing device in combination with a fluid impelling device in accordance with yet another embodiment of the invention.

FIGS. 9A-9F are linearized graphs respectively depicting various performance characteristics associated with a flow laminarizing device in accordance with the present invention.

FIG. 10 is a perspective view depicting a flow laminarizing device in accordance with still another embodiment of the invention.

### DETAILED DESCRIPTION

Currently, the air entering the compressor wheel (i.e., impeller) of a turbocharger in automotive (and other) applications passes through an air filter and air passageways with various bends and restrictions before entering the impeller. These restrictions and bends in the air passageway cause the air actually entering the impeller intake to be turbulent, resulting in less than optimum efficiency (i.e., performance) of the impeller of the turbocharger. Consequently, a given turbocharger typically provides, for example, an air compression ratio (i.e., the ratio of outlet pressure to inlet pressure) that is less than optimum for the given turbocharger.

This less-than-optimum performance generally extends to other kinds of fluid impelling devices for reasons similar to those presented above. Such other fluid impelling devices include, but are not limited to, the following: superchargers; centrifugal pumps; centrifugal fans; single-stage gas compressors; multistage gas compressors; and other kinds of devices which generally use one or more rotating elements to compress gases and/or induce fluid flow.

In representative embodiments, the present teachings provide methods and apparatus for laminarizing a fluid flow to a turbocharger or other fluid impelling device, typically improving the performance of the fluid impelling device.

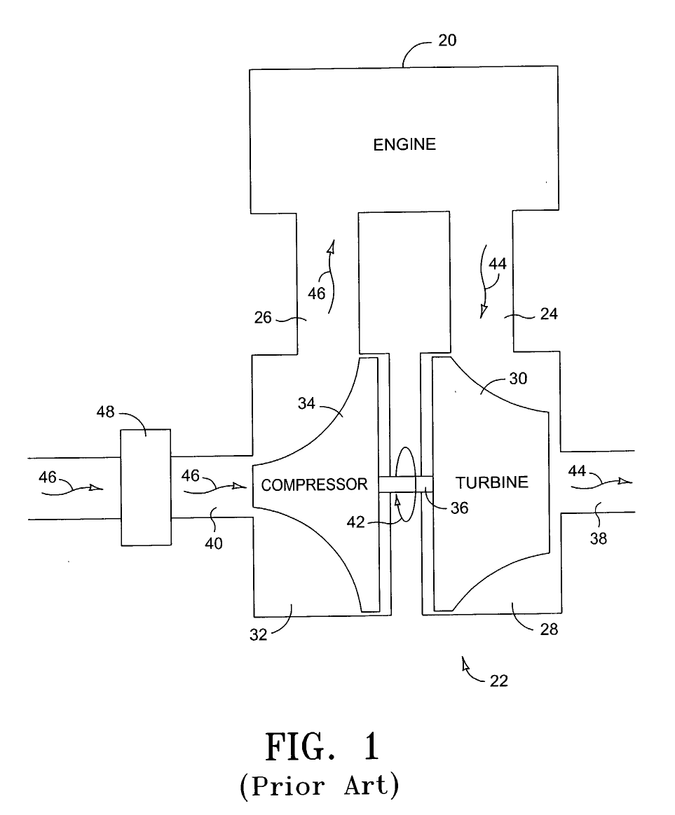

Turning now to FIG. 1, a schematic view depicts an engine 20 and an associated turbocharger 22, in accordance with the prior art. The engine 20 can be a diesel engine or a conventional gasoline engine. Generally, the engine 20 can be any type of internal combustion engine requiring an inlet flow of combustion air and producing an outlet flow of combustion exhaust gasses. The engine 20 is fluidly coupled to the turbocharger 22 by way of an exhaust gas conduit 24 and a combustion air conduit 26.

The turbocharger 22 includes a turbine chamber 28, which houses a turbine 30. The turbocharger 22 further includes a compression chamber 32, which houses an impeller 34. The turbine 30 is mechanically coupled to the impeller 34 by way of a rotatable shaft 36. The turbocharger 22 further includes an exhaust gas outlet 38 and an ambient air inlet 40.

Cooperation of the engine 20 and the turbocharger 22 is performed generally as follows: The engine 20 produces a flow of combustion exhaust gasses 44 that are coupled to the turbine chamber 28 by way of the exhaust conduit 24. The flow of exhaust gasses 44 drives a rotation 42 of the turbine 30. The exhaust gasses 40 continue to flow through the turbine chamber 28 and out of the turbocharger 22 by way of exhaust gas outlet 38.

The rotation 42 of the turbine 30 is coupled to the impeller 34 by way of the shaft 36. The impeller 34, thus rotating, impels (i.e., drives or induces) a flow of ambient air 46 into the compression chamber 32 by way of inlet 40. As shown in FIG. 1, the ambient air 46 is drawn through a filter 48 prior to flowing into the compression chamber 32. The ambient air 46 then continues to flow from the turbocharger 22 by way of the combustion air conduit 26, and is consumed in combustion by the engine 20.

The impeller 34 generally compresses the ambient air 46 within the compression chamber 32, resulting in an increase in pressure of the ambient air 46 at the combustion air conduit 26 (i.e., outlet pressure), relative to that of the ambient air inlet 40 (i.e., inlet pressure). As discussed briefly above, the performance of the turbocharger 22 (or any other fluid impelling device) can be expressed as a ratio of the outlet pressure to the inlet pressure, referred to herein as the performance ratio. Moreover, the performance ratio can be considered as indicative of the overall efficiency (or efficacy) of the turbocharger 22 (or another fluid impelling device).

As introduced above, turbulence within a fluid flow can result in a less-than-optimum performance ratio for a given fluid impelling device. In one case, for example, a swirling of the fluid in a direction counter to the rotation of the impeller can result in excessive drag. In another exemplary case, the fluid flow has a velocity profile relative to the cross-section of the flow-containing conduit, which is less than ideal for introduction to an impeller. Other aspects of turbulence within a fluid flow can have an undesired effect on the performance ratio of a fluid impelling device.

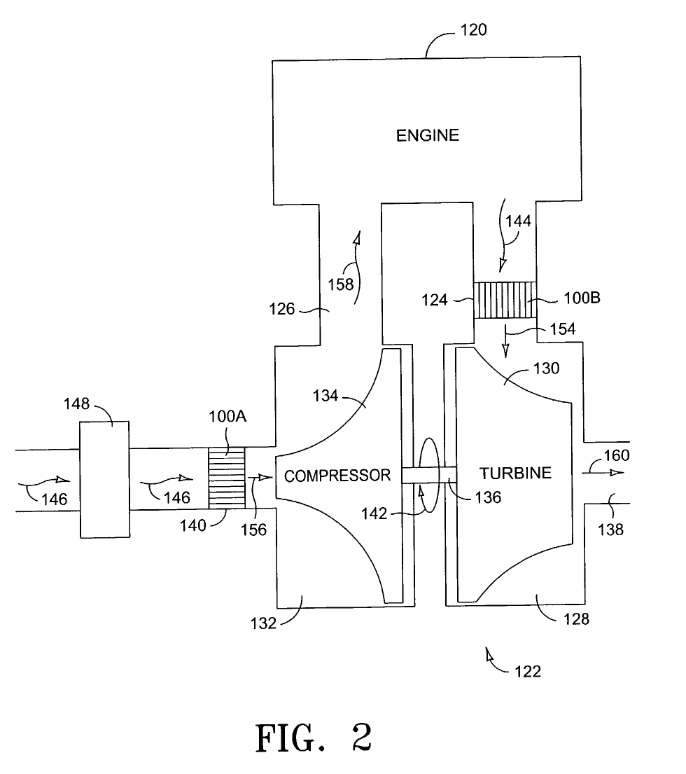

FIG. 2 is a schematic view depicting an engine 120 and an associated turbocharger 122, in accordance with an embodiment of the present invention. The engine 120 and the turbocharger 122 are coupled by way of an exhaust conduit 124 and a combustion air conduit 126. The turbocharger 122 includes a turbine chamber 128, a turbine 130, a compression chamber 132, an impeller 134, and a rotatable shaft 136, which function and cooperate substantially as described above for elements 28, 30, 32, 34 and 36, respectively.

Further depicted in FIG. 2 are a pair of flow laminarizing devices 100A and 100B, respectively. The flow laminarizing device 100A is shown installed in an ambient air inlet 140, generally in close adjacency to the impeller 134 of the turbocharger 122. The flow laminarizing device 100B is installed in an exhaust gas conduit 124, in generally close adjacency to the turbine 130 of the turbocharger 122.

Cooperation of the engine 120, the turbocharger 122 and the flow laminarizing devices 100A and 100B is performed generally as follows: Exhaust gasses 144 flow from the engine 120 and toward the turbine chamber 128 by way of the exhaust gas conduit 124. The exhaust gasses 144 flow through the flow laminarizing device 100B, which operates to substantially laminarize, or reduce any turbulence within, the flow of gasses 144 resulting in a laminarized exhaust gas flow 154. The laminarized gas flow 154 enters the turbine chamber 128 and drives a rotation 142 of the turbine 130. The exhaust gasses 144 then flow from the turbocharger 122 as exhaust discharge flow 160, by way of an exhaust gas outlet 138.

The impeller 134, rotating by way of the shaft 136, impels ambient air 146 to flow through a filter 148 and toward the compression chamber 132. The ambient air 146 flows through the flow laminarizing device 100A, which operates to laminarize the flow of air 146, resulting in a laminarized air flow 156. The laminarized air flow 156 enters the compression chamber 132 and is compressed by the impeller 134. The compressed ambient air 158 flows from the turbocharger 122 by way of the combustion air conduit 126, and is consumed by the engine 120.

The flow laminarizing device 100A generally increases the performance ratio (i.e., pressure ratio of compressed air 158 to laminarized air 156) of the turbocharger 122. Similarly, the flow laminarizing device 100B generally increases the efficiency of the turbine 130, such that the exhaust gasses 144 impart a reduced back pressure against the engine 120. In any case, the flow laminarizing devices 100A and 100B serve to generally improve, and can substantially optimize, the overall performance (i.e., the performance ratio) of the turbocharger 122.

As depicted in FIG. 2, the turbocharger 122 operates in conjunction with both flow laminarizing devices 100A and 100B. In another embodiment (not shown in FIG. 2), only the flow laminarizer 100A or 100B can be present, with the flow laminarizer 100A typically being selected for installation in a single-laminarizing-device embodiment. Other arrangements associated with other embodiments are possible.

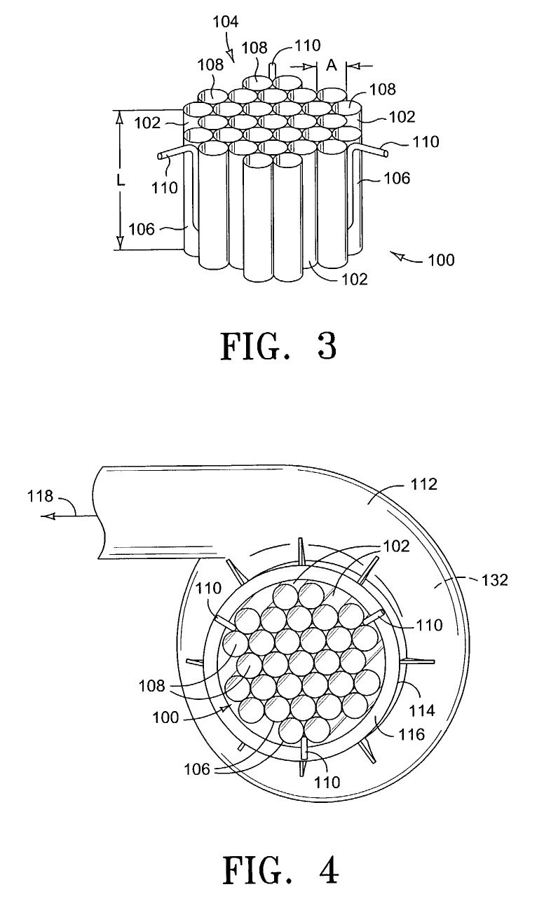

FIG. 3 is a perspective view of a flow laminarizing device 100, in accordance with another embodiment of the present invention. Embodiments of the flow laminarizing device 100 can be utilized, for example, as devices 100A and/or 100B of FIG. 2.

The flow laminarizing device 100 includes a plurality of tubes 102, which are coupled in a mutually parallel arrangement, generally defining a single array or cluster 104. Each of the tubes 102 includes a wall (or sidewall) 106, defining a passageway 108 that is configured to permit a fluid to flow there through. Each passageway 108 further has a length L and a cross-sectional area A, defined by the wall 106 of the corresponding tube 102. The plurality of tubes 102 can be formed of stainless steel, aluminum, or another suitable metal. Alternatively, the tubes 102 can be formed from plastic, nylon, a fiber and resin composite, or any other natural or synthetic material that is suitable for the application at hand (i.e., use with a turbocharger or another fluid impelling device).

The flow laminarizing device 100 further includes a plurality of retaining elements 110. The retaining elements 110 of the device 100 are typically uniformly spaced about the periphery of the array 104, and extend radially away there from. As depicted in FIG. 3, the retaining elements 110 have an overall “L” shape; it is understood that other forms of retaining elements corresponding to other embodiments of the invention are possible. The retaining elements 110 are configured to support, or maintain, the flow laminarizing device 100 in a substantially fixed position with respect to a location of use (not shown in FIG. 3; refer to FIG. 4). The retaining elements 110 can be formed from any material suitable for use with the plurality of tubes 102 and/or the application at hand.

FIG. 4 is a perspective view depicting the flow laminarizing device 100 of FIG. 3, in typical usage combination with a turbocharger 112. As depicted, the turbocharger 112 includes an inlet or throat 114. The flow laminarizing device 100 is received in the inlet 114, being maintained in place by cooperation of the retainer elements 110 with an edge or lip 116 of the inlet 114.

In typical operation, an ambient air conduit (not shown) fluidly couples air with the flow laminarizing device 100 and the turbocharger 112. At least a portion of the air flowing toward the inlet 114 of the turbocharger 112 passes through the passageways 108 and exits the flow laminarizing device 100 as a substantially laminar air stream. The laminar air stream continues through the remainder of the inlet 114, and into an air compression chamber 116 of the turbocharger 112. An impeller (not shown) of the turbocharger 112 generally compresses the air flow, and discharges it along a path 118 for consumption by an engine (not shown).

Performance of the flow laminarizing device 100 can be generally characterized as follows: An increase in the number of tubes 102 (i.e., increase in the number of corresponding passageways 108) within an array 104 of a substantially constant overall size typically increases the flow laminarizing effect of the device 100, but also typically increases drag on the fluid flowing there through (i.e., fluid drag) due to an increase in the surface area (tube length times tube inside circumference) which the air can contact in passing through the device. An increase in the length “L” of the tubes typically increases both the flow laminarizing effect and the fluid drag of the particular passageway 108. An increase in the surface roughness of the wall 106 defining the passageway 108 will decrease the flow laminarizing effect. Conversely, an increase in the cross-sectional area A typically results in a decrease of both the flow laminarizing effect and the fluid drag of the particular passageway 108.

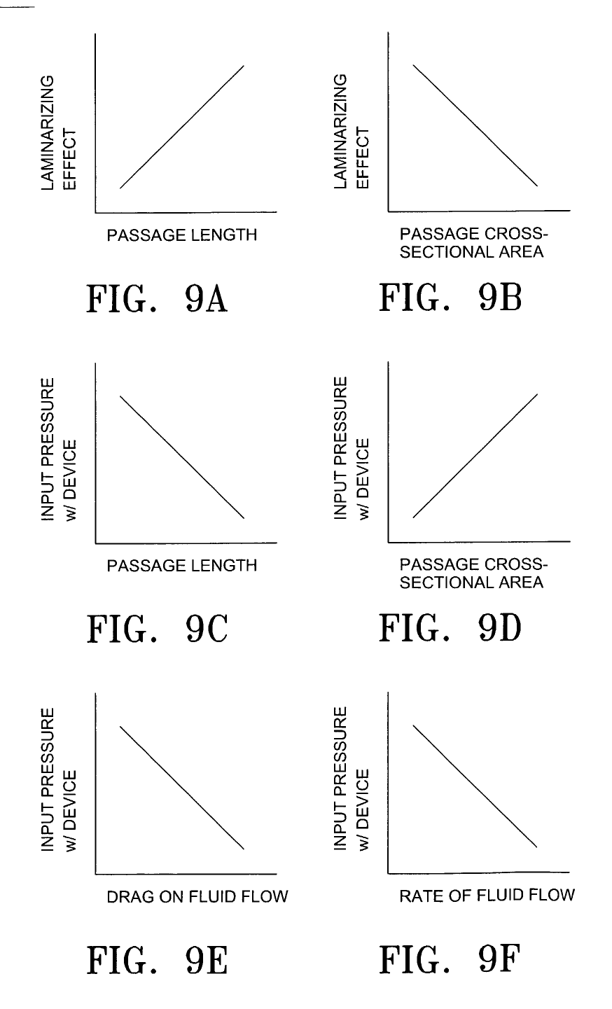

Other effects resulting from the number of tubes 102 (i.e., passageways 108) and their associated characteristics and dimensions can also be present; however, it those effects stated above that are of primary concern herein. In any case, it is generally desirable to realize an embodiment of the flow laminarizing device 100 such that a ratio of the flow laminarizing effect, to the fluid drag there produced, is optimized for the application at hand—that is, the kind and size of fluid impelling device, type of flowing fluid, location of the flow laminarizing device relative to the fluid impelling device, etc. Such design optimization typically requires an iterative approach, and the acquisition of empirical data associated with the application at hand. This topic will be discussed more fully below with respect to FIGS. 9A-9F.

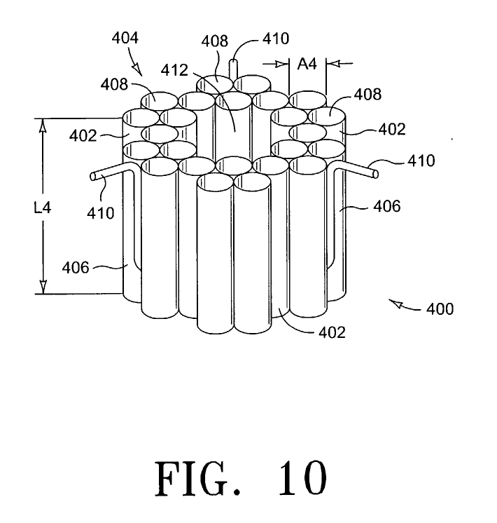

FIG. 10 is a perspective view depicting a flow laminarizing device 400 in accordance with still another embodiment of the invention, which is generally similar to the flow laminarizing device 100 described above. The flow laminarizing device 400 includes a plurality of tubes 402, which are coupled in a mutually parallel arrangement, defining an array or cluster 404. Each of the tubes 402 includes a wall 406, defining a passageway 408 that is configured to permit fluid flow there through. Each of the tubes 402 further includes a length L4 and cross-sectional area A4, defined by the corresponding wall 406.

The tubes 402 of the cluster 404 are further generally arranged about the periphery of, and thus define, a central passageway 412. Function of the central passageway 412 will be described in detail here after. The flow laminarizing device 400 further includes a plurality of retaining elements 410. The plurality of retaining elements 410 are typically coupled to and are uniformly distributed about the periphery of the cluster 404 of the tubes 402. The plurality of retaining elements 410 are configured to support the flow laminarizing device 400 in a substantially fixed position relative to a location of use, such as, for example, the fluid inlet (or throat) of a turbocharger (not shown) or other fluid impelling device (not shown).

The tubes 402 and the retaining elements 410 of the flow laminarizing device 400 can be formed from any material or materials suitable for the intended use, such as, for example, any of the materials described above in regard to the formation of the flow laminarizing device 100. Optionally, the flow laminarizing device 400 can be formed as a single-piece entity, of any suitable material, and by any correspondingly suitable method of formation. For example, the flow laminarizing device 400 can be formed as a single-piece, injection-molded plastic entity. In another example, the flow laminarizing device 400 can be at least partially formed of an extruded metal. Other materials and/or methods for producing the flow laminarizing device 400 are possible.

The operation and performance characteristics of the flow laminarizing device 400 are substantially similar to those described above in regard to the flow laminarizing device 100 of FIG. 3. Furthermore, the central passageway 412 is configured to permit the flow laminarizing device 400 to be positioned in relatively close, non-contacting proximity to an impeller of a turbocharger (not shown) or other fluid impelling device (not shown). This can be accomplished, for example, by receiving a portion of the impeller (not shown) into the central passageway 412. In this way, fluid (i.e., air) is introduced to the impeller (not shown) immediately upon exiting the flow laminarizing device 400, while the fluid flow still retains most or all of the laminarizing characteristic provided by the flow laminarizing device 400.

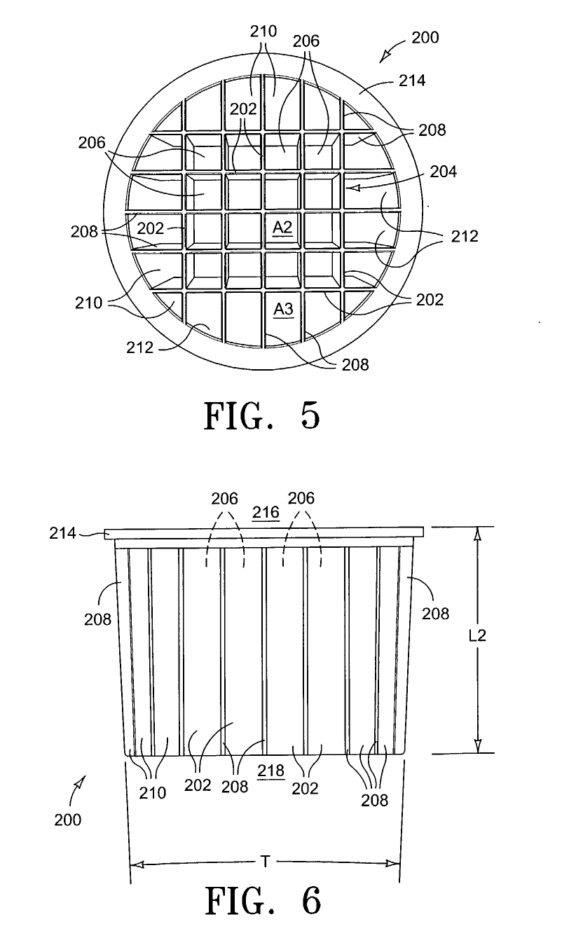

FIG. 5 is an end plan view depicting a flow laminarizing device 200 in accordance with yet another embodiment of the invention. The flow laminarizing device 200 includes a first plurality of first walls 202. The first walls 202 are coupled so as to define a plurality of passageways 206. The plurality of passageways 206 are substantially mutually parallel and arranged as an array 204. As depicted, each of the passageways 206 has a generally square cross-sectional area A2, in accordance with the arrangement of the particular walls 202 defining each passageway 206. It is understood that other passageways (not shown) having different cross-sectional geometries such as, for example, triangular, hexagonal, octagonal, etc., associated with other embodiments of the invention (not shown), can also be used. Accordingly, the term “wall” or “walls” as used herein should not be considered as limiting structures to open planar shapes, but is also meant to include closed shapes (such as circular, square, polygonal, elliptical, etc.)

The flow laminarizng device 200 further includes a second plurality of second walls 208. The second walls 208 are coupled with each other and with the first walls 202, and thus define a plurality of channels 210. The channels 210 are generally disposed about the periphery of the array 204 of the passageways 206. Each of the channels 210 is further defined by an open side 212. As depicted, each of the channels 210 has a generally rectangular, or triangular, open, cross-sectional area A3, in accordance with the second walls 202, the open side 212, and the first wall 202 (where applicable) defining each channel 210. It is understood that other channels (not shown) having different cross-sectional geometries such as, for example, hexagonal, octagonal, etc., associated with other embodiments of the invention, can also be used.

The flow laminarizing device 200 further includes a retaining element 214, coupled to the first and second walls 202 and 208, respectively. In this example, the retaining element 214 is formed as a ring, or annulus, and is configured to support or hold the flow laminarizing device 200 in a substantially fixed position during typical operation (shown and described hereafter).

FIG. 6 is a side elevational view depicting the flow laminarizing device 200 of FIG. 5. The flow laminarizing device 200 further is of a length L2, as defined by the first and second walls 202 and 208, respectively. Thus, each of the passageways 206 and channels 210 are of this length L2. The fluid laminarizing device 200 further includes a fluid entrance end 216 and a fluid exit end 218. As depicted, the fluid entrance end 216 is generally proximate to the retaining element 214, while the fluid exit end 218 is generally distal to the retaining element 214. The plurality of second walls 208 are formed (i.e., angled) such that the flow laminarizing device 200 includes a taper T, from the entrance end 216 to the exit end 218.

The flow laminarizing device 200 can be formed from any material suitable for the intended use, and is preferably formed as a single-piece entity (i.e., not from an assemblage of discrete pieces). In one preferred embodiment, the flow laminarizing device 200 is formed as a single, injection-molded plastic entity. In another embodiment, the flow laminarizing device 200 is formed in a metallic extrusion process. Other materials and methods of formation, associated with other embodiments of the flow laminarizing device 200, are possible.

Furthermore, the flow laminarizing device 200 exhibits performance characteristics that are substantially similar to those described above for the flow laminarizing device 100. For example, an increase of the length L2 of the device 200 generally corresponds to increasing both the flow laminarizing effect and the fluid drag of the device 200. As another example, an increase of the cross-sectional areas A2 and A3 generally corresponds to a decrease in both the flow laminarizing effect and fluid drag of the flow laminarizing device 200. Other general characteristic similarities can exist between the respective flow laminarizing devices 100 and 200.

It is therefore desirable to realize an embodiment of the flow laminarizing device 200 such that a ratio of the flow laminarizing effect, to the fluid drag there produced, is optimized for the application at hand—typically, laminarizing an ambient air flow into a compression chamber of a turbocharger. In one non-limiting example, the flow laminarizing device 200 includes: a length L of about 30 mm; a total of sixteen passageways 206, each having a cross-sectional area A2 of about 0.81 cm\hat{ }2; and a total of twenty channels 210, each having an entrance end 216 cross-sectional area A3 in the range of about 0.18 cm\hat{ }2 to about 1.1 cm\hat{ }2. Other dimensions and pluralities of passageways 206 and channels 210, associated with other embodiments of the flow laminarizing device 200, are also possible.

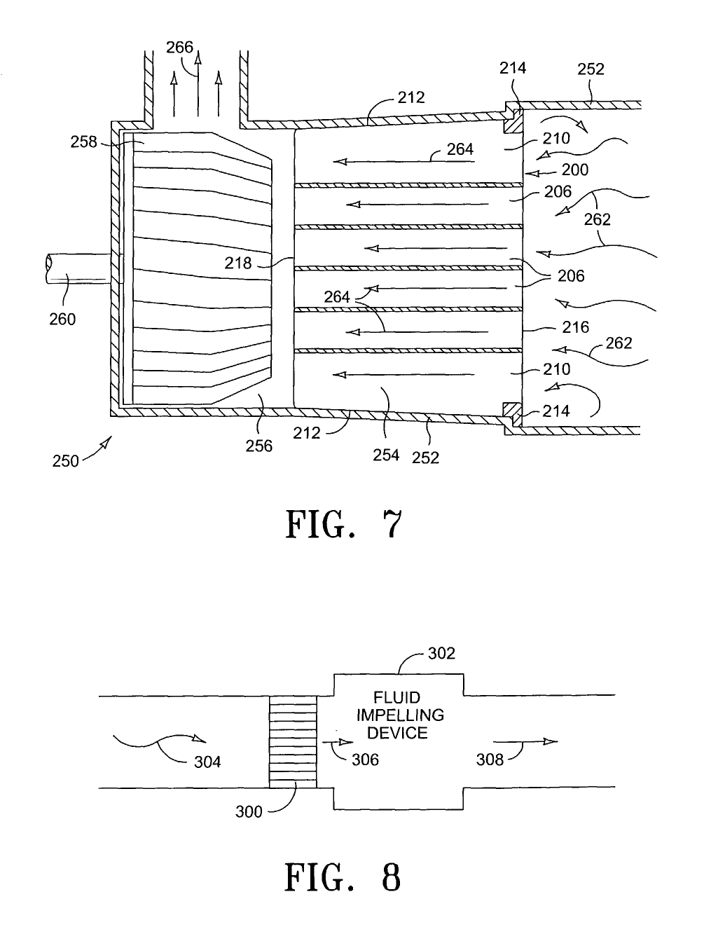

FIG. 7 is a side elevation sectional view depicting the flow laminarizing device 200 of FIG. 5 in cooperation with a portion of a turbocharger 250. The turbocharger 250 includes a housing 252, which defines an inlet 254 and a compression chamber 256. The flow laminarizing device 200 is received within the inlet 254, with the retainer element 214 cooperating with the housing 252 (in addition to other possible elements, not shown) to hold the flow laminarizing device 200 in a generally fixed position. The turbocharger 250 further includes an impeller 258 that is supported within the compression chamber 256 by way of coupling to a rotatable shaft 260.

Cooperation of the flow laminarizing device 200 and the turbocharger 250 is performed typically as follows: The shaft 260 is driven to rotation by an attached turbine (not shown) of the turbocharger 250, which in turn rotates the impeller 258. The rotating impeller 258 impels a flow of generally turbulent ambient air 262 toward the fluid entrance end 216 of the flow laminarizing device 200. The flow of the ambient air 262 divides to form a plurality of individual flow streams 264, which respectively enter the plurality of passageways 206 and channels 210 of the flow laminarizing device 200.

The individual flow streams 264 are laminarized (i.e., made more laminar, or reduced in turbulence) as they flow from the entrance end 216 to the exit end 218 of the flow laminarizing device 200. The plurality of flow streams 264 then exit the flow laminarizing device 200 and flow into the compression chamber 256 of the turbocharger 258, where they interact with the impeller 258. The impeller 258 generally compresses the ambient air 262 of the plurality of flow streams 264, such that a single, combined flow stream 266 of ambient air 262 is discharged from the turbocharger 250.

As depicted in FIG. 7, the inlet 254 of the turbocharger 250 has a general taper leading into the compression chamber 256. It is noted that this taper is accommodated by the taper T of the flow laminarizing device 200, such that the housing 252 of the inlet 254 cooperates to substantially close the open sides 212 of the channels 210 of the flow laminarizing device 200. In this way, the respective cross-sectional areas A3 of the channels 210 effectively decrease along a path from the entrance end 216 to the exit end 218. It is well known to those of skill in the art that fluid flow generally accelerates under such conditions, leading to a higher velocity at the exit end 218 than at the entrance end 216, for those flow streams 264 that flow through the channels 210. The relative velocity of the individual flow streams 264 is shown in the form of corresponding vector length within FIG. 7.

Furthermore, the individual air streams 264 flowing from the central passageways 206 typically have the lowest exit velocities, with the exit velocity of the air streams 264 generally increasing when flowing from the peripheral passageways 206 and the channels 210. This general exit-velocity characteristic is believed to improve the overall performance of the flow laminarizing device 200 in at least the following ways:

1) The higher velocity air streams 264 tend to draft, or boost, the lower velocity air streams 264, due to respectively different static pressures; and

2) The peripheral, higher velocity air streams 264 tend to desirably interact with the features of the impeller 258 which are moving with the greatest linear (i.e., tangential) velocity.

Other performance benefits attributable to the taper T of the flow laminarizing device 200 can also be present or realized. In any case, the flow laminarizing device 200 generally improves, and can substantially optimize, the performance ratio of the turbocharger 250 for reasons similar to those described above for the flow laminarizing device 100 of FIG. 2.

Although the flow laminarizing devices 100 and 200 have been exemplarily shown as being used with a turbocharger, it will be appreciated that the devices can also be used on the air inlet to a supercharger (which is directly mechanically driven by a belt or gears or the like, rather than being driven by exhaust gasses).

FIG. 8 is a schematic view depicting a flow laminarizing device 300, operating in conjunction with a generic fluid impelling device 302. The flow laminarizing device 300 is understood to be generic to the instant invention, and includes a plurality of passageways and/or channels (not shown), which are formationally and characteristically similar to those described above for the flow laminarizing devices 100 and 200.

In operation, a fluid (i.e., liquid or gas) 304, having a generally turbulent flow characteristic, flows toward the flow laminarizing device 300, and passes there through. The flow laminarizing device 300 substantially reduces the turbulence (i.e., laminarizes) of the fluid, resulting in the generally laminarized flow 306 of the fluid 304. The laminarized flow 306 of the fluid 304 enters the fluid impelling device 302, where it interacts with an impeller (not shown), resulting in compression and/or flow induction of the fluid 304. The fluid 304 then exits the fluid impelling device 302 as an exit flow 308.

The fluid 304 of the exit flow 308 generally has a higher static pressure, upon exiting the fluid impelling device 302, than does the fluid 304 of the laminarized flow 306. As described above, the ratio of the exit flow 308 pressure, to the laminaried (i.e., inlet) flow 306 pressure, is referred to herein as the performance ratio of the fluid impelling device 302, and is generally considered to provide an overall benchmark, or standard, by which to evaluate the performance of the generic fluid impelling device 302.

The flow laminarizing device 300 is used in conjunction with the fluid impelling device 302, so as to increase, or optimize, the performance ratio of the fluid impelling device 302, by substantially reducing or eliminating the undesired effects of introducing the turbulent flow of fluid 304 directly to the generic fluid impelling device 302. These undesired effects can include, but are not limited to, drag due to counter-rotation of the fluid flow with respect to the rotation of the impeller, and a less-than-optimum velocity profile of the fluid flow, etc.

FIG. 9A is a linearized, graphical representation depicting the general correspondence between the laminarizing effect, and the passageway or channel length, of a flow laminarizing device (not shown) generic to the instant invention. In general, an increase of passageway or channel length typically results in an increase of the laminarizing effect of the associated flow laminarizing device.

FIG. 9B is a linearized, graphical representation depicting the general correspondence between the laminarizing effect, and the passageway or channel cross-sectional area, of a flow laminarizing device (not shown) generic to the instant invention. In general, an increase of passageway or channel cross-sectional area typically results in a decrease in the laminarizing effect of the associated flow laminarizing device.

FIG. 9C is a linearized, graphical representation depicting the general correspondence between the static pressure of a laminarized fluid entering a generic fluid impelling device (not shown), and the passageway or channel length of a flow laminarizing device (not shown) generic to the instant invention. In general, an increase in the passageway or channel length results in a decrease in the static pressure of the fluid entering the fluid impelling device (and after passing through the flow laminarizing device).

FIG. 9D is a linearized, graphical representation depicting the general correspondence between the static pressure of a laminarized fluid entering a generic fluid impelling device (not shown), and the passageway or channel cross-sectional area of a flow laminarizing device (not shown) generic to the instant invention. In general, an increase in the passageway or channel cross-sectional area results in an increase in the static pressure of the fluid entering the fluid impelling device (and after passing through the flow laminarizing device).

FIG. 9E is a linearized, graphical representation depicting the general correspondence between the static pressure of a laminarized fluid entering a generic fluid impelling device (not shown), and the drag on that fluid (resulting from wall roughness) as it flows through a flow laminarizing device (not shown) generic to the instant invention. In general, an increase in drag on the flowing fluid (corresponding to an increase in the coefficient of drag on the wall surface) results in a decrease in the static pressure of that fluid as it enters the fluid impelling device.

FIG. 9F is a linearized, graphical representation depicting the general correspondence between the static pressure of a laminarized fluid entering a generic fluid impelling device (not shown), and the rate of flow of that fluid through a flow laminarizing device (not shown) generic to the instant invention. In general, an increase in rate of fluid flow results in a decrease in the static pressure of that fluid as it enters the fluid impelling device after passing through the flow laminarizing device.

FIGS. 9A-9F are not intended as representing empirical data, but are only depicted to show the general relationship between the design variables and the performance characteristics of a flow laminarizing device in accordance with the present invention. In designing such a flow laminarizing device, the length of the walls (or fluid passageways), as well as the inner circumference of the passageways, are optimized to increase the laminarizing effect on the fluid, and thus efficiency of a device using the laminarized flow, while at the same time reducing the pressure loss imposed on the fluid by the flow laminarizing device. Surface roughness of the wall surfaces of the flow laminarizing device should be reduced whenever practical, and can be achieved by using materials have low drag coefficients after being formed (such as extruded TFE), or by being polished.

One method for designing a flow laminarizing device in accordance with the present invention is to select a number of fluid passageways and a length for the device. The length is preferably selected to be longer than is believed reasonable. The device can then be placed in the inlet to a centrifugal compressor, and the compressor driven at a fixed rotational speed. The pressure of the air exiting the compressor (discharge pressure) is then measured as is compared to a base-line measurement made without the device in place. The length of the device can then be shortened by a selected increment (as by cutting, for example), and the discharge pressure measured again with the shortened device in place. Generally, the discharge pressure will increase as the length of the device is shortened. However, at a certain point the discharge pressure will start to drop as the device becomes “too short” to produce a useful laminarizing effect. When this occurs, then the last selected length is the near-optimum length of this device.

Once a near-optimum length for the device is determined (as just discussed), then the near-optimum number of passageways can be determined. Preferably, the initial number of passageways selected is greater than what is believed to be practical. The number of passageways can then be incrementally decreased, and the effect on the discharge pressure observed with the altered device. As with the length determining process, the discharge pressure will be observed to increase as the number of passageways is decreased. However, at a certain point the discharge pressure will start to decrease as the number of passageways are decreased, indicating a loss of flow laminarizing benefit fro the device. The last-used number of fluid passageways will then be the near-optimum number of fluid passageways.

It will be appreciated that the above iterative design method is practical for designing a flow laminarizing device in accordance with the present invention due to the variables inherent in the system in which the device will be used, as well as the difficulties of performing fluid flow calculations for compressible fluids. However, the design process can also be performed on a computer using compressible fluid flow design software, such as “PIPE-FLO Compressible”, available from Engineered Software, Inc. of Lacey, Wash., U.S.A.

It will also be appreciated that a similar design methodology is applied when the flow laminarizing device under consideration is to be used on the inlet side of a turbine, when energy is to be extracted from the fluid (such as on the driving side of a turbocharger, or the inlet to a turbine in a hydraulic power generator), rather than energy being input into the fluid. In the instance where energy is being extracted from the fluid, rather than driving the turbine at a fixed speed and measuring outlet pressure of the fluid from the turbine, the turbine can be free-wheeling and the rotational speed of the turbine can be measured as the flow laminarizing device is altered (i.e., length shortened and number of passageways decreased). In general, the rotational speed will increase as these two variables are altered up to a certain point, at which point the rotational speed will start to decrease as the flow laminarizing effect is lost. The design points where the rotational speed ceases to increase and starts to decrease are the near-optimal design points.

From the foregoing it will be appreciated that another embodiment of the present invention provides for a method for using a turbocharger including an impeller. The method includes laminarizing a flow of air or gas using a flow laminarizing device, and providing the laminarized flow of air or gas to the impeller of the turbocharger. Yet another embodiment provides for a method for using a diesel engine including a turbocharger. In this latter embodiment a flow of combustion gasses is received from the diesel engine at the turbocharger, and a flow of ambient air is received at the turbocharger. The method includes laminarizing at least one of the flow of combustion gasses or the flow of ambient air prior to the receiving at the turbocharger using a flow laminarizing device. Still another embodiment of the present invention provides for a method for using a fluid impelling device. This method includes laminarizing a fluid flow using a flow laminarizing device, and providing the laminarized fluid flow to the fluid impelling device.

While the above methods and apparatus have been described in language more or less specific as to structural and methodical features, it is to be understood, however, that they are not limited to the specific features shown and described, since the means herein disclosed comprise preferred forms of putting the invention into effect. The methods and apparatus are, therefore, claimed in any of their forms or modifications within the proper scope of the appended claims appropriately interpreted in accordance with the doctrine of equivalents.

I claim:

1. A turbocharger, comprising an impeller, a fluid inlet to the impeller, and an outlet from the impeller, and a flow laminarizing device disposed within at least one of the inlet to the impeller or the outlet from the impeller, the flow laminarizing device comprising:
a plurality of walls defining a plurality of passageways, the passageways being substantially mutually parallel and configured to permit fluid flow there through.

2. The turbocharger of claim 1, and wherein the plurality of walls comprises at least one of a plurality of tubes, an extruded material, a molded material, a composite material, a synthetic material, a metallic material, a material defining an array of cells, or a single piece entity.

3. The turbocharger of claim 1, and wherein the flow laminarizing device further comprises at least one retaining element configured to support the flow laminarizing element in a substantially fixed position relative to the turbocharger.

4. The turbocharger of claim 3, and wherein the at least one retaining element comprises a ring.

5. A diesel engine, comprising:
a plurality of combustion chambers, each combustion chamber configured to receive ambient air and to discharge combustion gases;
a turbocharger configured to receive the ambient air, compress the ambient air, and provide the compressed ambient air to the plurality of combustion chambers, the turbocharger being further configured to receive and be driven by the discharged combustion gasses; and
a flow laminarizing device configured to laminarize a flow of one of the ambient air to the turbocharger or the combustion gasses to the turbocharger.

6. The diesel engine of claim 5, and wherein the flow laminarizing device comprises a plurality of walls defining a plurality of passageways, each passageway configured to permit fluid flow there through.

7. The diesel engine of claim 6, and wherein the plurality of walls comprises at least one of a plurality of tubes, an extruded material, a molded material, a composite material, a synthetic material, a metallic material, a material defining an array of cells, or a single piece entity.

8. The diesel engine of claim 5, and wherein the flow laminarizing device comprises a retaining element configured to support the flow laminarizing device in a substantially fixed position relative to the turbocharger, and wherein the retaining element is optionally defined by a ring.

9. A flow laminarizing device, comprising:
a first plurality of first walls defining a plurality of passageways, the plurality of passageways being substantially mutually parallel and disposed as an array, each of the passageways including open opposite ends and configured to permit fluid flow there through;
a second plurality of second walls defining a plurality of channels, the plurality of channels being substantially parallel with each other and the plurality of passageways, each channel including at least one open side and open opposite ends and configured to permit fluid flow there through; and
a retainer configured to support the flow laminarizing device in a substantially fixed position with respect to a location of use, and wherein the retainer optionally comprises a ring.

10. The flow laminarizing device of claim 9, and wherein the flow laminarizing device is at least partially defined by a molded entity, an extruded entity, a cast entity, a composite entity, or a single piece entity.

11. The flow laminarizing device of claim 9, and wherein the flow laminarizing device comprises at least one of a composite material, a synthetic material, a material defining an array of cells, or a metallic material.

12. The flow laminarizing device of claim 9, and wherein each of the plurality of second walls is configured such that the flow laminarizing device includes a taper from a fluid entrance end to a fluid exit end.

13. A flow laminarizing device, comprising:
a plurality of walls each including a wall length and a wall width and a wall area, the plurality of walls configured to define a plurality of passageways, the plurality of passageways being substantially mutually parallel, each of the passageways including a passage length corresponding to the wall lengths defining the passageway, each of the passageways including an internal wall area corresponding to the sum of the wall areas of the walls defining the passageway, each of the passageways including a cross-sectional area corresponding to the wall widths of the walls defining the passageway, each of the passageways including an open entrance end and an open exit end and configured to permit a fluid flow there through, each of the passageways configured to generally laminarize the fluid flowing there through, wherein an increase of the passage length of a particular passageway generally increases both the laminarizing of, and a drag effect on, the fluid flowing there through, and wherein an increase of the internal wall area of a particular passageway generally increases the drag effect on the fluid flowing there through, and wherein an increase of the cross-sectional area of a particular passageway generally decreases both the laminarizing of, and the drag effect on, the fluid flowing there through, and wherein an increase of a surface smoothness of the walls defining a particular passageway generally decreases the drag effect on the fluid flowing there through.

14. The flow laminarizing device of claim 13, and wherein the plurality of walls are further configured to substantially optimize a ratio of the laminarizing of, to the drag effect on, the fluid flowing through the plurality of passageways.

15. The flow laminarizing device of claim 13, and wherein flow laminarizing device is configured to be used in fluid communication with a fluid impelling device, and wherein the plurality of walls are further configured to substantially optimize a ratio of an output pressure to an input pressure of a fluid impelled by the fluid impelling device.

16. The flow laminarizing device of claim 13, and wherein the plurality of walls are further configured to define a central passageway, and wherein the plurality of passageways are generally distributed about the periphery of the central passageway.

17. The flow laminarizing device of claim 16, and wherein the flow laminarizing device is further configured to be used in substantially fixed, close, non-contacting proximity to an impeller of a fluid impelling device.
